(19) United States
(12) Patent Application Publication
(10) Pub. No.: US 2012/0306163 A1
(43) Pub. Date: Dec. 6, 2012

(54) SEAL AND HOUSING HAVING SUCH A SEAL

(75) Inventors: Christoph GRONAUER, Stein (DE); Herbert RIEGEL, Oberdachstetten (DE)

(73) Assignee: HYDROMETER GMBH, Ansbach (DE)

(21) Appl. No.: 13/478,347

(22) Filed: May 23, 2012

(30) Foreign Application Priority Data
May 31, 2011 (DE) 10 2011 102 922.6

(51) Int. Cl. F16J 15/06; F16L 17/06

(52) U.S. Cl. 277/611; 277/608

(57) ABSTRACT

The invention relates to a seal for the connecting region (2) between a housing connection piece (3) of a flowmeter (4) and a pipe end or pipe bushing (5), the seal (1) having a first sealing component (6) made from soft material, the seal (1) comprising additionally at least one second sealing component (7) made from a material which is harder than that of the first sealing component (6).

### BACKGROUND OF THE INVENTION

The invention relates to a seal for the connecting region between a housing connection piece of a flowmeter and a pipe end or pipe bushing, the seal having a first sealing component made from soft material.

### DISCUSSION OF THE PRIOR ART

Flowmeters are used for detecting the liquid quantity flowing through a hollow line. The flowmeter is in this case inserted into the pipe in such a way that the liquid flowing through the pipe is also led through the flowmeter. For this purpose, the respective housing connection piece of the flowmeter is inserted between the two pipe ends or pipe bushings arranged thereon. To seal off the connecting region between the housing connection piece and the pipe end or pipe bushing, flat seals are provided. These flat seals have hitherto satisfied the requirements, since the housing of the flowmeter is made from brass, which is distinguished by low thermal expansion even when hot water flows through. Furthermore, the pipelines usually consist of copper and have a certain length (approximately 1 metre), with the result that they are relatively flexible. The seals customary hitherto can seal off the connecting point in the event of temperature fluctuations or other insignificant movements.

If, however, the housing of the flowmeter consists of plastic, these components are subject in the event of temperature fluctuations to corresponding thermal expansions, and therefore simple flat seals no longer afford sufficient leak-tightness.

### SUMMARY OF THE INVENTION

The object on which the present invention is based is, therefore, to make available a seal for the connecting region between the housing connection piece of a flowmeter and a pipe end or pipe bushing, which seal also fulfils the requirements in the event of temperature fluctuations and the associated thermal expansions of the components adjacent to the connecting region.

This invention is achieved by virtue of the overall teaching of Patent Claim 1. Advantageous developments of the invention will be gathered from subclaims 2-13. An advantageous housing of a flowmeter is taught in Claims 14 and 15.

The seal according to the invention has a first sealing component made from soft material and additionally at least one second sealing component made from a material which is harder than that of the first sealing component. Such a seal is suitable especially for flowmeters, the housing of which consists of plastic, since this has relatively high heat or thermal expansion in the case of a variation in temperature, in particular in the temperature of the medium flowing through. The length offset discovered as a result of this heat expansion or when the flowmeter is in its installation situation can be compensated ideally by means of this seal, which behaves reversibly with the two different sealing components. Complete compression and therefore destruction of the entire seal are prevented by the hard sealing component, while the soft sealing component preserves the sealing. In particular, the seal can be positioned in the flange region of the pipe end or pipe bushing and the end-face region of the housing connection piece. In this case, the said seal can expediently be laid around the entire circumference of the flange or housing connection piece.

The first sealing component is provided essentially for sealing off the connecting region and the second sealing component is provided essentially for absorbing the pressure force of the two structural parts. The hard sealing component at the same time ensures that a limit is applied to the compressed seal, that is to say prevents the said seal from being squeezed together completely. By contrast, the second sealing component can always continue to perform its sealing-off function.

The first and the second sealing components may expediently be in direct contact with one another, so that their respective functions can be performed or take effect directly in relation to one another or to the entire seal in the respective connecting region. Moreover, only a small amount of space is therefore required, without a structural change in the structural parts to be connected having to be carried out.

The second sealing component may be arranged externally around the first sealing component. Depending on the type or range of use of the flowmeter, the first sealing component may also be arranged externally around the second sealing component. The respective sealing component may therefore lie internally or externally, that is to say be arranged so as to face or face away from the longitudinal axis of the pipe.

The first and the second sealing components may be provided as separate parts. The sealing components can thereby be produced separately from one another in a cost-effective way. Depending on the type of material of the sealing components, it may be advantageous if the two sealing components merely bear one against the other and do not make a materially integral connection.

However, the first and the second sealing components may also be connected to one another. The seal can therefore be inserted as one part into the connecting region in a simple way. Mounting can consequently become simpler.

The seal may be produced as a two-component injection moulding. The sealing components are thus connected to one another permanently and reliably. As a one-part seal, it can then be inserted in a simple way.

Depending on the materials of the sealing components there may also be provision whereby the first sealing component is injection-moulded behind or at least partially around the second sealing component. The properties of the two different materials are also thereby combined in one structural part. Furthermore, it becomes possible to produce a ready-to-mount seal in one manufacturing step. A materially integral connection may be made, such as, for example, a metal/plastic or plastic/plastic connection.

The second sealing component with the harder material may have a lower thickness than the first sealing component with the soft material. This ensures that, when the structural parts are pressed together, the sealing-off function of the seal takes effect first, followed by the limiting or force-absorbing function of the hard sealing component.

In order to implement this, the second sealing component may be arranged so at to be set back with respect to the first sealing component, for example both sealing components bearing flush against the flange of the pipe end or pipe bushing and forming a step on the side pointing away from the pipe end. When the housing connection piece is screwed to the pipe end or pipe bushing, the soft sealing component is then compressed first and the harder sealing component is stressed only in the event of a further change in the geometric dimensions of the connecting point, for example under temperature fluctuations.

The first sealing component may advantageously consist of an elastomer, rubber or caoutchouc, which all have elastic properties, that is to say are deformed elastically under pressure load and then returned to their original configuration again. These materials are especially suitable for sealing. The first sealing component may consist, for example, of EPDM, TPE or NBR. TPE, above all, is especially suitable for the two-component injection-moulding method.

The second sealing component may consist of a hard plastic or metal. The plastic may be, for example, PP or PE, and, for example, brass may be used as metal.

Furthermore, protection is claimed for a housing of a flowmeter with a housing connection piece, on which a seal for connecting to a pipe end or pipe bushing is arranged, the seal being designed according to at least one of the features described above. The flowmeter can therefore be equipped at once with the seal, thus making mounting-friendly installation possible.

The housing connection piece or the entire housing of the flowmeter may consist of plastic. Although plastic reacts in the event of temperature fluctuations by having corresponding heat expansions, the connecting point between the housing or housing connection piece and the pipe end can be sealed off reliably by means of the seal according to the invention. Even in hot-water applications, a length-compensating element in the meter is not necessary because of this seal.

### BRIEF DESCRIPTION OF THE DRAWINGS

The invention is explained in more detail by means of an exemplary embodiment according to the drawing figures in which:

FIG. 1: shows a side view of a flowmeter inserted into a pipeline,

FIG. 2: shows a top view of the flowmeter according to FIG. 1, inserted in a pipeline, along the sectional line II-II, and

FIG. 3: shows an illustration of the detail element III of a section of the connecting region between the pipe bushing and housing connection piece from FIG. 2.

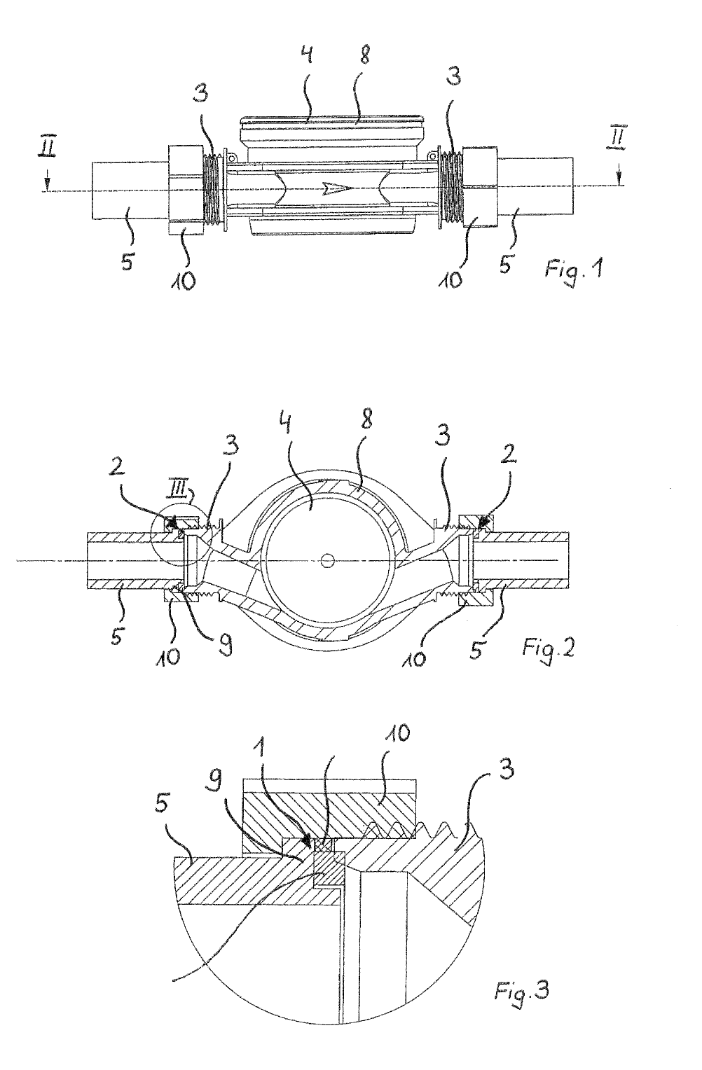

### DETAILED DESCRIPTION OF THE INVENTION

Reference numeral 1 designates the seal which is provided for the connecting region 2 between a housing connection piece 3 of flowmeter 4 and a pipe bushing 5. The seal 1 comprises a first sealing component 6 made from soft material and a second sealing component 7 made from a material which is harder than that of the first sealing component 6. The properties of the two sealing components 6 and 7 are therefore combined in the seal 1. The housing 8 of the flowmeter 4 and therefore also the housing connection piece 3 consist of plastic which, as compared, for example, with brass, has a relatively high coefficient of expansion or coefficient of thermal expansion. When temperature fluctuations occur (in this area of use the temperature spreads may amount to up to 90° C., for example because of hot water flowing through), the plastic housing reacts by having corresponding heat expansions or contractions. The seal 1 with its two different components is especially suitable for the connection between such a plastic housing and a pipe bushing, since it also behaves reversibly in these situations. Furthermore, it may also happen that the connection point between the two pipe bushings 5 is rigid, and therefore a relatively motionless installation situation arises. The seal 1 is especially suitable even for these cases.

As is clear from the drawing figures, the housing connection piece 3 is screwed into the flange 9 of the pipe bushing 5. The seal 1 is located between the flange 9 and the end face of the housing connection piece 3. Connection is secured by means of a union nut 10.

The first sealing component 6 is provided essentially for sealing off the connecting region or connecting point 2 and the second sealing component 7 is provided essentially for absorbing the pressure force between the pipe bushing 5 and housing connection piece 3. The second and hard sealing component 7 at the same time prevents the soft sealing component from being compressed too severely and therefore damaged. The second sealing component 7 consequently also fulfils the function of limiting the compression of the entire seal 1 and thus ensures that the seal 1 behaves reversibly.

The first sealing component 6 and the second sealing component 7 are in direct contact with one another, so that the respective functions take effect directly at the corresponding point.

The second sealing component 7 is arranged outside the first sealing component 6, both sealing components 6, 7 bearing against the flange 9.

The first 6 and the second 7 sealing components are connected to one another and are manufactured as a two-component injection moulding. The seal 1 is therefore in one part and can be inserted into the connecting point 2 in a mounting-friendly way. Moreover, the two sealing components 6, 7 are consequently connected to one another permanently and reliably.

Depending on the materials of the sealing components, one sealing component may also be injection-moulded behind or at least partially around the other. Furthermore, however, the sealing components may also be present as separate parts.

In this case, the second sealing component 7 is arranged so as to be set back with respect to the first sealing component 6 in the direction of the housing connection piece 3. The second sealing component 7 has a lower thickness than the first sealing component, thus ensuring that the first and soft sealing component 6 can fully perform it sealing action and at the same time the second sealing component 7 serves only for the absorption of force.

The first sealing component 6 consists of an elastomer, rubber or caoutchouc, such as, for example, EPDM, TPE or NBR. TPE is especially suitable for the two-component injection-moulding method.

The second sealing component 7 consists of a hard plastic, such as, for example, PP or PE. This is likewise suitable for the two-component injection-moulding method. The second sealing component 7 may also consist of metal, for example brass, the first sealing component 6 being injection-moulded behind or at least partially around the second sealing component 7 when the seal 1 is being produced.

As already stated above, the entire housing 8 of the flowmeter 4 consists of plastic. The seal 1 makes it possible to provide reliable, reversible sealing-off between this plastic housing and a pipe bushing 5 made from metal.

### LIST OF REFERENCES

1) Seal
2) Connecting region
3) Housing connection piece
4) Flowmeter
5) Pipe bushing
6) First sealing component
7) Second sealing component
8) Housing
9) Flange
10) Union nut

What is claimed is:

1. A seal for the connecting region between a housing connection piece of a flowmeter and a pipe end or pipe bushing, the seal having a first sealing component made from soft material, wherein the seal comprises additionally at least one second sealing component made from a material which is harder than that of the first sealing component.

2. The seal according to claim 1, wherein the first sealing component is provided essentially for sealing off the connecting region and the second sealing component is provided essentially for absorbing the pressure force of the housing connection piece and pipe end or pipe bushing.

3. The seal according to claim 1, wherein the first and the second sealing components are in direct contact with one another.

4. The seal according to claim 1, wherein the second sealing component is arranged externally around the first sealing component.

5. The seal according to claim 1, wherein the first sealing component is arranged externally around the second sealing component.

6. The seal according to claim 1, wherein the first and the second sealing components are separate parts.

7. The seal according to claim 1, wherein the first and the second sealing components are connected to one another.

8. The seal according to claim 1, wherein the seal is produced as a two-component injection moulding.

9. The seal according to claim 1, wherein the first sealing component is injection-moulded behind or at least partially around the second sealing component.

10. The seal according to claim 1, wherein the second sealing component has a lower thickness than the first sealing component.

11. The seal according to claim 1, wherein the second sealing component is arranged so as to be set back with respect to the first sealing component.

12. The seal according to claim 1, wherein the first sealing component consists of an elastomer, rubber or caoutchouc.

13. The seal according to claim 1, wherein the second sealing component consists of a hard plastic or metal.

14. A housing of a flowmeter with a housing connection piece, on which a seal for connecting to a pipe end or pipe bushing is arranged, wherein the seal is designed according to claim 1.

15. The housing according to claim 14, wherein the housing connection piece or the entire housing consists of plastic.
